(19) United States
(12) Patent Application Publication
(10) Pub. No.: US 2019/0283470 A1
(43) Pub. Date: Sep. 19, 2019

(54) TRANSPORTATION DEVICE AND IMAGE FORMING APPARATUS

(71) Applicant: FUJIFILM Corporation, Tokyo (JP)

(72) Inventor: Yoshiyuki OKAYAMA, Kanagawa (JP)

(73) Assignee: FUJIFILM Corporation, Tokyo (JP)

(21) Appl. No.: 16/431,758

(22) Filed: Jun. 5, 2019

Related U.S. Application Data
(63) Continuation of application No. PCT/JP2017/043757, filed on Dec. 6, 2017.

(30) Foreign Application Priority Data
Jan. 31, 2017 (JP) 2017-015859

(51) Int. Cl. B41J 13/22; B41J 11/00; B65H 5/08; B65H 5/22

(52) U.S. Cl. CPC B41J 13/22; B65H 5/22; B65H 5/08; B41J 11/002

(57) ABSTRACT

A transportation device includes a transportation mechanism that, in a state in which a front end portion of a sheet is gripped, transports the sheet, a first guide that is arranged along a transportation path where the sheet is transported by the transportation mechanism, and that contacts a non-image surface of the sheet, a blowing device that presses the sheet that is being transported by the transportation mechanism against the first guide, and an attraction transportation portion that is arranged on a downstream side in a transportation direction of the sheet with respect to the first guide, that attracts the non-image surface of the sheet that is being transported in a state in which the sheet is pressed against the first guide, and that transports with the transportation mechanism the sheet in a state in which the non-image surface is attracted.

### CROSS-REFERENCE TO RELATED APPLICATIONS

This application is a Continuation of PCT International Application No. PCT/JP2017/043757 filed on Dec. 6, 2017, which claims priority under 35 U.S.C § 119(a) to Japanese Patent Application No. 2017-015859 filed on Jan. 31, 2017. Each of the above application(s) is hereby expressly incorporated by reference, in its entirety, into the present application.

### BACKGROUND OF THE INVENTION

### 1. Field of the Invention

The technology of the present disclosure relates to a transportation device and an image forming apparatus.

### 2. Description of the Related Art

An ink jet recording apparatus that suppresses peeling of a rear end portion of a sheet from an outer peripheral surface of an image formation drum by blowing wind against a transportation-direction central portion of the sheet whose front end portion is gripped by a chain gripper is disclosed in JP2015-30203A.

A sheet discharge device provided with a fan that blows air from above a bent paper guide in the sheet discharge device that discharges, by a chain gripper, paper printed by a sheet-feed printer is disclosed in JP1994-29834U (JP-H06-29834U).

An ink jet recording apparatus in which a ribbed guide member for bending a rear-surface side of a recording medium into a convex shape and transporting the rear-surface side of the recording medium is provided with a hole from which cold air comes out and in which smoothing means that performs oblique blowing towards a recording-medium rear-end side is provided is disclosed in JP2011-168019A.

### SUMMARY OF THE INVENTION

Here, in a state in which the front end portion of the transport material, such as a sheet, is gripped by the chain gripper, in a case where the transport material is transported, the transport material may flutter on the rear end side with respect to the gripped front end portion. In particular, in a case where the rear end portion of the transport material is not constrained, the transport material easily flutters on the rear end side with respect to the gripped front end portion.

In a configuration in which the transport material that is being transported by the chain gripper is attracted to a transportation belt and the transport material in an attracted state is transported, in a case where the transport material in a fluttered state is attracted to the transportation belt, attraction wrinkles may be produced in the transport material.

Although, as in the technologies disclosed in JP2015-30203A, JP1994-29834U, and JP2011-168019A, in a case where wind is caused to strike the transport material, fluttering of the transport material is suppressed, the technologies in JP2015-30203A, JP1994-29834U, and JP2011-168019A are not technologies that cause wind to strike the transport material in a case where the transport material is attracted to the transportation belt. Therefore, in the technologies in JP2015-30203A, JP1994-29834U, and JP2011-168019A, attraction wrinkles that are produced due to fluttering of the transport material cannot be suppressed.

An object of the technology of the present disclosure is to provide a transportation device and an image forming apparatus, which can suppress attraction wrinkles that are produced due to fluttering of a transport material.

A transportation device according to a first aspect includes a transportation mechanism that, in a state in which a front end portion of a sheet-shaped transport material is gripped, transports the transport material, a contact portion that is arranged along a transportation path where the transport material is transported by the transportation mechanism, and that contacts one surface of the transport material, a pressing mechanism that presses the transport material that is being transported by the transportation mechanism against the contact portion, and an attraction transportation portion that is arranged on a downstream side in a transportation direction of the transport material with respect to the contact portion, that attracts the one surface of the transport material that is being transported in a state in which the transport material is pressed against the contact portion, and that transports with the transportation mechanism the transport material in a state in which the one surface is attracted.

According to the transportation device according to the first aspect, the transportation mechanism transports the sheet-shaped transport material in a state in which the front end portion of the transport material is gripped. The pressing mechanism presses the transport material that is being transported by the transportation mechanism against the contact portion.

By the pressing mechanism pressing the transport material against the contact portion, fluttering of the transport material is suppressed. In addition, the transport material that is being transported in a state in which fluttering is suppressed by the pressing mechanism is attracted to the attraction transportation portion, and the transport material is transported by the attraction transportation portion and the transportation mechanism. Therefore, it is possible to suppress attraction wrinkles that are produced due to fluttering of the transport material.

In a transportation device according to a second aspect, in the transportation device of the first aspect, the pressing mechanism presses the transport material that is being transported by the transportation mechanism against the contact portion and the attraction transportation portion.

According to the transportation device according to the second aspect, the pressing mechanism presses the transport material not only against the contact portion but also against the attraction transportation portion.

In a transportation device according to a third aspect, in the transportation device of the first aspect or the second aspect, the pressing mechanism contactlessly presses the transport material that is being transported by the transportation mechanism.

According to the transportation device according to the third aspect, the pressing mechanism contactlessly presses the transport material that is being transported by the transportation mechanism.

In a transportation device according to a fourth aspect, in the transportation device of the third aspect, the pressing mechanism presses the transport material that is being transported by the transportation mechanism by blowing.

Here, as a configuration that contactlessly presses the transport material, for example, a configuration that presses by blowing or a configuration that presses the transport material by a repelling force using, for example, an electrostatic force or a magnetic force is considered. In the case using an electrostatic force, the transport material is required to have a predetermined electrical resistance value. In the case using a magnetic force, the transport material is required to be magnetic. In contrast, according to the transportation device according to the fourth aspect, since blowing is used, the transport material is not required to have a predetermined electrical resistance value or to be magnetic.

In a transportation device according to a fifth aspect, in the transportation device of the fourth aspect, the pressing mechanism presses the transport material by blowing from a plurality of nozzles arranged at equal intervals.

According to the transportation device according to the fifth aspect, compared to a configuration in which a plurality of nozzles are not arranged at equal intervals, it is possible to cause wind to uniformly strike each portion of the transport material.

In a transportation device according to a sixth aspect, in the transportation device of the fourth aspect, the pressing mechanism has an arrangement member that is arranged along the transportation direction, a plurality of openings being formed in the arrangement member in an inclination direction in which the openings are inclined with respect to the transportation direction, and the pressing mechanism presses the transport material by blowing from the openings.

According to the transportation device according to the sixth aspect, the openings are inclined with respect to the transportation direction.

In a transportation device according to a seventh aspect, in the transportation device of any one of the fourth aspect to the sixth aspect, the pressing mechanism blows the transport material in a range that is narrower than a width in a direction orthogonal to the transportation direction of the transport material and along the one surface of the transport material.

According to the transportation device according to the seventh aspect, in the range that is narrower than the width of the transport material having the maximum width, it is possible to blow the transport material having the maximum width.

In a transportation device according to an eighth aspect, in the transportation device of any one of the fourth aspect to the seventh aspect, the pressing mechanism blows the transport material towards both end sides from a center in a width direction orthogonal to the transportation direction of the transport material and along the one surface of the transport material and towards an upstream side in the transportation direction.

According to the transportation device according to the eighth aspect, it is possible to press and extend the transport material towards both the end sides from the center in the width direction and towards the upstream side in the transportation direction.

In a transportation device according to a ninth aspect, in the transportation device of any one of the first aspect to the eighth aspect, the contact portion has a plurality of holes formed in a contact surface that contacts the one surface of the transport material.

According to the transportation device according to the ninth aspect, air between the transport material and the contact portion can be made to escape via the plurality of holes.

In the transportation device of the ninth aspect, a transportation device according to a tenth aspect includes a suction unit that sucks air via the plurality of holes of the contact portion.

According to the transportation device according to the tenth aspect, air between the transport material and the contact portion can be made to escape.

In a transportation device according to an eleventh aspect, in the transportation device of the tenth aspect, the attraction transportation portion attracts the one surface by a suction force that is generated by sucking air, and a suction force in the suction unit is smaller than the suction force in the attraction transportation portion.

According to the transportation device according to the eleventh aspect, the suction unit performs sucking with a suction force that is smaller than the suction force in the attraction transportation portion.

In a transportation device according to a twelfth aspect, in the transportation device of any one of the ninth aspect to the eleventh aspect that depend upon the fourth aspect, an opening ratio of the holes is larger on both end sides in a width direction orthogonal to the transportation direction of the transport material and along the one surface of the transport material than at a center side in the width direction.

According to the transportation device according to the twelfth aspect, wind that has flown to side end sides (both the end sides in the width direction) of the transport material can be made to effectively escape via the holes.

In a transportation device according to a thirteenth aspect, in the transportation device of any one of the ninth aspect to the eleventh aspect that depend upon the fourth aspect, the contact portion has a convex portion where a contact surface that contacts the one surface of the transport material is higher at a center in a width direction orthogonal to the transportation direction of the transport material and along the one surface of the transport material than both end sides in the width direction, and a height of the convex portion is higher on the downstream side than on the upstream side in the transportation direction.

According to the transportation device according to the thirteenth aspect, wind from the pressing mechanism flows on the contact surface towards both the end sides from the center in the width direction of the transport material, and flows towards the upstream side from the downstream side in the transportation direction. Therefore, by the wind from the pressing mechanism, the transport material is pressed and extended on the contact surface towards both the end sides from the center in the width direction and towards the upstream side from the downstream side in the transportation direction.

An image forming apparatus according to a fourteenth aspect includes an image forming unit that forms an image on an image surface of a recording medium, and the transportation device according to any one of first aspect to the thirteenth aspect that transports, as the transport material, the recording medium on which the image has been formed by the image forming unit, wherein the contact portion comes into contact with, as the one surface, a non-image surface of the recording medium, and the pressing mechanism contactlessly presses the image surface of the recording medium to press the recording medium against the contact portion.

According to the image forming apparatus according to the fourteenth aspect, the recording medium is contactlessly pressed.

In an image forming apparatus according to a fifteenth aspect, in the image forming apparatus of the fourteenth aspect, the image forming unit is an image forming unit that forms the image by water-based ink, and the image forming apparatus includes a drying unit that dries the recording medium that is being transported by the transportation mechanism and the attraction transportation portion in a state in which the non-image surface of the recording medium is attracted to the attraction transportation portion of the transportation device.

According to the image forming apparatus according to the fifteenth aspect, the recording medium is dried in a state in which attraction wrinkles are suppressed.

In an image forming apparatus according to a sixteenth aspect, in the image forming apparatus of the fifteenth aspect, the pressing mechanism of the transportation device presses the recording medium by warm air.

According to the image forming apparatus according to the sixteenth aspect, warm air is caused to strike the recording medium.

According to the technology of the present disclosure, it is possible to suppress attraction wrinkles that are produced due to fluttering of the transport material.

### BRIEF DESCRIPTION OF THE DRAWINGS

FIG. 1 simplifies and illustrates an image forming apparatus according to a first embodiment;

FIG. 2 simplifies and illustrates a portion of the image forming apparatus according to the first embodiment;

FIG. 3 is a perspective view illustrating a first guide according to the first embodiment;

FIG. 4 is a perspective view illustrating a blowing device according to the first embodiment;

FIG. 5 is a perspective view of the blowing device according to the first embodiment as seen from a bottom wall side;

FIG. 6 is a plan view illustrating the relationship between the width of the blowing device according to the first embodiment and the width of a sheet;

FIG. 7 illustrates a situation in which an attraction wrinkle is produced in a sheet on a transportation belt according to the first embodiment;

FIG. 8 simplifies and illustrates a portion of an image forming apparatus according to a second embodiment;

FIG. 9 is a bottom view illustrating a bottom wall in a blowing device according to a third embodiment;

FIG. 10 is a bottom view illustrating a bottom wall in a blowing device according to a modification of the third embodiment;

FIG. 11 is a bottom view illustrating a blowing device according to a fourth embodiment;

FIG. 12 illustrates a blowing device according to a fifth embodiment as seen towards a downstream side from an upstream side in a transportation direction;

FIG. 13 is a side view of a blowing device according to the fifth embodiment;

FIG. 14 is a plan view illustrating a sheet pressed by the blowing device according to the fifth embodiment;

FIG. 15 is a perspective view illustrating a first guide according to a sixth embodiment;

FIGS. 16A and 16B are sectional views illustrating a first guide according to a seventh embodiment;

FIG. 17 simplifies and illustrates a portion of an image forming apparatus according to an eighth embodiment;

FIG. 18 is a schematic view illustrating a modification in which a blowing width of a blowing device is made variable; and

FIG. 19 is a table showing evaluation results.

### DESCRIPTION OF THE PREFERRED EMBODIMENTS

An exemplary embodiment according to the present invention is described below on the basis of the drawings.

### First Embodiment

### Image Forming Apparatus 10

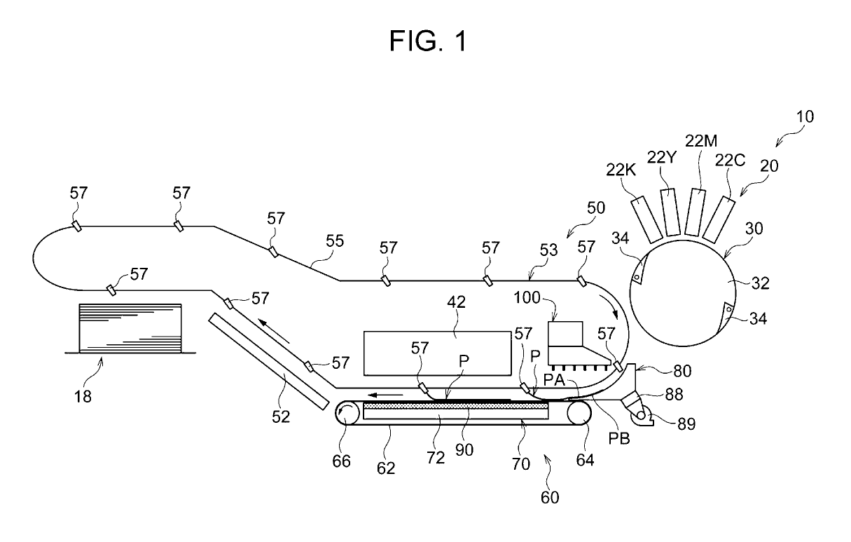

First, an image forming apparatus 10 according to a first embodiment is described. FIG. 1 simplifies and illustrates a configuration of the image forming apparatus 10.

The image forming apparatus 10 is a device that forms an image on a sheet P, serving as an example of a recording medium, by an ink jet method by using water-based ink (ink using a water-based medium). The sheet P may be, for example, a sheet of paper. The sheet P is an example of a sheet-shaped transport material.

Specifically, as illustrated in FIG. 1, the image forming apparatus 10 has an image forming unit 20, a transportation device 50, a drying unit 42, and a sheet discharge unit 18. Specific configurations of the image forming unit 20, the transportation device 50, the drying unit 42, and the sheet discharge unit 18 are described below.

### Image Forming Unit 20

The image forming unit 20 is an image forming unit that forms an image on a sheet P with water-based ink. Specifically, the image forming unit 20 has a transportation drum 30, and ejection heads 22C, 22M, 22Y, and 22K.

The transportation drum 30 transports a sheet P supplied from a supply section (not illustrated). Specifically, the transportation drum 30 has a cylindrical drum main body 32 and grippers 34.

The drum main body 32 is rotated by a motor (not illustrated) while attracting a sheet P to an outer peripheral surface by suction. The grippers 34 are swingably provided on the drum main body 32 at two locations in a peripheral direction of the drum main body 32. The grippers 34 are each an example of a gripping unit that grips a front end portion of a sheet P. The front end portion of the sheet P is an end portion of the sheet P on a downstream side in a transportation direction.

In the transportation drum 30, in a state in which the front end portion of the sheet P supplied from the supply section (not illustrated) is gripped by the grippers 34, while winding the sheet P around an outer peripheral surface of the drum main body 32 by rotation of the drum main body 32, the sheet P is attracted to the outer peripheral surface of the drum main body 32. Further, by the rotation of the drum main body 32, the sheet P is transported towards the transportation device 50.

The ejection heads 22C, 22M, 22Y, and 22K are provided on an upper side of the transportation drum 30 so as to face the outer peripheral surface of the drum main body 32. The ejection heads 22C, 22M, 22Y, and 22K are composed of line heads having a length greater than or equal to the sheet width of the sheet P. The sheet width of the sheet P means the size of the sheet P in a direction orthogonal to the transportation direction of the sheet P and along the outer peripheral surface of the drum main body 32.

The ejection heads 22C, 22M, 22Y, and 22K eject water-based inks of respective colors, cyan (C), magenta (M), yellow (Y), and black (K), onto the sheet P that is being transported by the transportation drum 30. This causes an image to be formed on an image surface PA of the sheet P.

### Transportation Device 50

The transportation device 50 is a device that transports a sheet P on which an image has been formed by the image forming unit 20. Specifically, the transportation device 50 has a transportation mechanism 53, a first guide 80, serving as an example of a contact portion, a blowing device 100, serving as an example of a pressing mechanism, a transportation unit 60, and a second guide 52. Specific configurations of the transportation mechanism 53, the first guide 80, the blowing device 100, the transportation unit 60, and the second guide 52 are described below.

### Transportation Mechanism 53

The transportation mechanism 53 is a transportation mechanism that transports a sheet P in a state in which a front end portion of the sheet P is gripped. Specifically, the transportation mechanism 53 has a pair of ring chains 55 and a plurality of grippers 57. Each gripper 57 has a length along a width direction of the sheet P (a depth direction in a paper plane in FIG. 1). Each gripper 57 has a function of gripping the front end portion of the sheet P from one end portion to the other end in the width direction. The width direction of the sheet P is a direction orthogonal to the transportation direction of the sheet P and along the image surface PA.

The chains 55 are arranged on one end side and the other end side in a length direction of the grippers 57. In FIG. 1, one chain 55 of the pair of chains 55 is illustrated. Each chain 55 is wound around two sprockets (not illustrated), and, by rotation of one of the two sprockets, the chains 55 circulate in a clockwise direction in FIG. 1. The plurality of grippers 57 are arranged at the chains 55 so as to be spaced apart from each other in a circulation direction of the chains 55. One end portion and the other end portion in the length direction of each gripper 57 are each mounted on a corresponding one of the pair of chains 55.

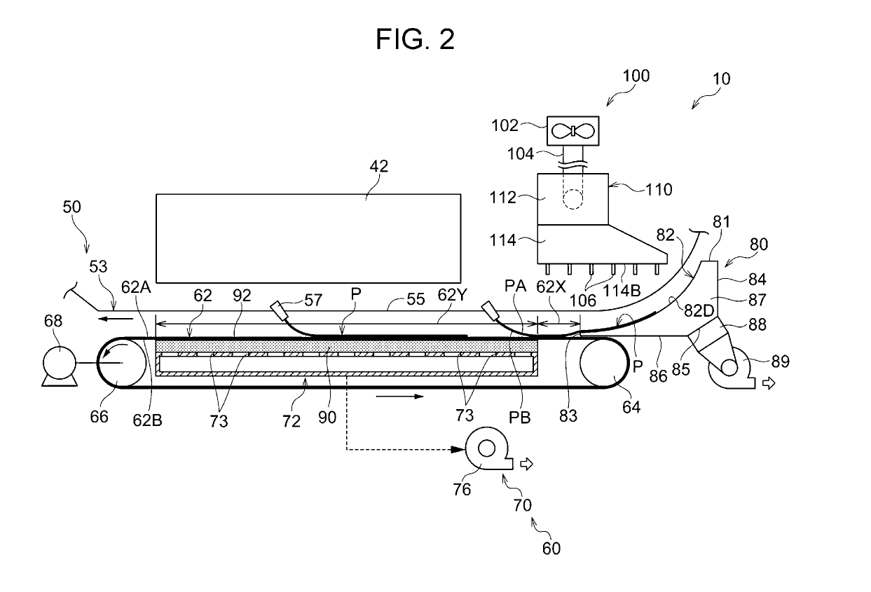

In the transportation mechanism 53, in a state in which the grippers 57 grip the front end portion of the sheet P transferred from the transportation drum 30, by circulating the chains 55, the sheet P is transported. In a state in which the image surface PA on which the image is formed in the sheet P faces the chains 55 as seen from a side surface (refer to FIG. 2), the transportation mechanism 53 transports the sheet P. In the transportation mechanism 53, a rear end portion of the sheet P is transported in an unconstrained state in which the rear end portion of the sheet P is not constrained.

### First Guide 80

The first guide 80 (an example of a contact portion) is arranged on a downstream side of the image forming unit 20 in the transportation direction of the sheet P so as to face the chains 55. The first guide 80 has a length along the width direction of the sheet P (a depth direction of a paper plane in FIG. 2).

As illustrated in FIG. 2, the first guide 80 is an example of a guide unit that guides the sheet P towards the downstream side in the transportation direction by coming into contact with a non-image surface PB (an example of one surface) of the sheet P that is being transported by the transportation mechanism 53. The non-image surface PB is a surface on the opposite side of the image surface PA of the sheet P.

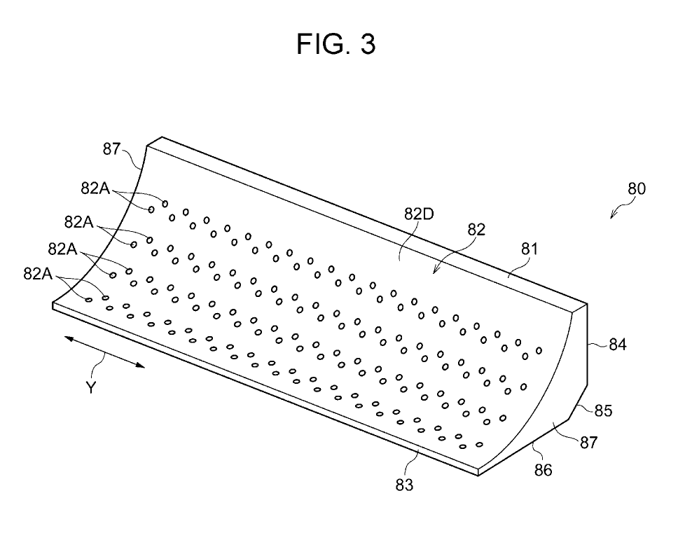

The first guide 80 is formed in a box shape having a hollow in an internal portion thereof. Specifically, as illustrated in FIG. 3, for example, the first guide 80 has an upper wall 81, an arc wall 82, an end wall 83, a rear wall 84, an inclined wall 85, a bottom wall 86, and a pair of side walls 87. The hollow of the internal portion of the first guide 80 is formed by being surrounded by the upper wall 81, the arc wall 82, the end wall 83, the rear wall 84, the inclined wall 85, the bottom wall 86, and the pair of side walls 87.

As illustrated in FIG. 2, the arc wall 82 faces the chains 55, and is formed in an arc shape along a circulation path of the chains 55 as seen from the side surface (refer to FIG. 2). The arc wall 82 is an example of a guide wall that guides a sheet P by a contact surface 82D coming into contact with the non-image surface PB of the sheet P. The contact surface 82D is a cylindrical surface along the circulation path of the chains 55.

As illustrated in FIG. 3, a plurality of suction holes 82A (examples of holes) that pass through the arc wall 82 in a thickness direction thereof are formed in the contact surface 82D of the arc wall 82. The plurality of suction holes 82A are holes through which ventilation air passes in a case where air outside the first guide 80 moves to the internal portion of the first guide 80. The plurality of suction holes 82A are arranged two-dimensionally. Specifically, by arranging the plurality of suction holes 82A side by side at equal intervals along a width direction of the arc wall 82 (direction of arrow Y in FIG. 3), rows of holes are formed, and the plurality of the rows of holes are arranged along the transportation direction of the sheet P. The width direction of the arc wall 82 is the same as the width direction of the sheet P. In the width direction of the arc wall 82, the opening ratio of the plurality of suction holes 82A is constant.

As illustrated in FIG. 2, the upper wall 81 protrudes from an upper end (upstream end) of the arc wall 82 towards a rightward side of FIG. 2 (in a horizontal direction away from the chains 55). The upper wall 81 faces upward. The end wall 83 protrudes from a lower end (downstream end) of the arc wall 82 towards a downward side (vertical direction away from the chains 55). The end wall 83 faces a leftward side of FIG. 2 (downstream side in the transportation direction). It is desirable that the height of the end wall 83 be as low as possible.

The rear wall 84 extends towards the downward side from a right end of the upper wall 81 in FIG. 2. The rear wall 84 faces the rightward side of FIG. 2. The bottom wall 86 protrudes from a lower end of the end wall 83 towards the rightward side of FIG. 2. The bottom wall 86 faces downward.

The inclined wall 85 connects a lower end of the rear wall 84 and a right end of the bottom wall 86 to each other. The inclined wall 85 faces an obliquely lower right direction of FIG. 2. The pair of side walls 87 are each connected to a corresponding one of one end and the other end in a width direction of each of the upper wall 81, the arc wall 82, the end wall 83, the rear wall 84, the inclined wall 85, and the bottom wall 86. The width directions of the upper wall 81, the end wall 83, the rear wall 84, the inclined wall 85, and the bottom wall 86 are the same as the width direction of the sheet P and the width direction of the arc wall 82.

One end portion of an air suction pipe 88 is connected to a width-direction central portion of the inclined wall 85. The width-direction central portion of the inclined wall 85 is a center and a substantial center of the inclined wall 85 in the width direction of the inclined wall 85. The air suction pipe 88 communicates with the internal portion of the first guide 80. A blower 89 is connected to the other end portion of the air suction pipe 88. By operating the blower 89, air on an outer side of the arc wall 82 is sucked via the internal portion of the first guide 80 and the suction holes 82A. That is, the blower 89 is an example of a suction unit that sucks air via the suction holes 82A.

A suction force that is generated by the blower 89 is smaller than a suction force that is generated by a blower 76 (described below). In a gauge pressure where the atmospheric pressure is 0 Pa, for example, the pressure at the transportation unit 60 is −5 kPa to −10 kPa (−5 kPa and −10 kPa inclusive). In contrast, in a gauge pressure where the atmospheric pressure is 0 Pa, for example, the pressure at the suction holes 82A is −10 Pa to −100 Pa (−10 Pa and −100 Pa inclusive).

### Blowing Device 100

The blowing device 100 is an example of a pressing mechanism that presses a sheet P that is being transported by the transportation mechanism 53 against the first guide 80 by blowing. Specifically, as illustrated in FIG. 2, the blowing device 100 has a device main body 110, a blowing machine 102, serving as a blowing section, a connection pipe 104, and a plurality of nozzles 106.

The blowing machine 102 is a machine that causes wind (air flow) to be generated. As the blowing machine 102, for example, a centrifugal-type blowing machine and an axial-flow-type blowing machine can be used. The temperature of the wind that is generated by the blowing machine 102 is normal temperature. The blowing section may be a compressor that pressure-feeds air.

An internal portion of the device main body 110 is hollow. Specifically, the device main body 110 has an inflow unit 112 where the wind (air flow) from the blowing machine 102 flows into the internal portion, and an outflow unit 114 where the wind (air current) that has flown into an internal portion of the inflow unit 112 is caused to flow out.

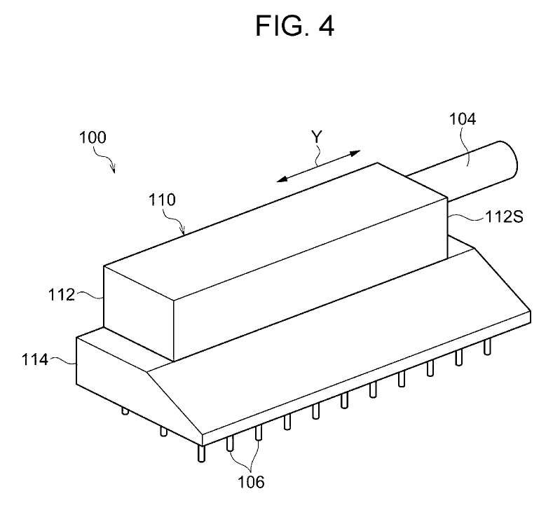

The inflow unit 112 is composed of a box body whose bottom portion is open. As illustrated in FIG. 4, the box body is formed from a parallelepiped body having a length along the width direction of the sheet P (direction of arrow Y of FIG. 4). The outflow unit 114 is composed of a box body whose top portion is open. As seen from the side surface (refer to FIG. 2), this box body is formed in a substantially trapezoidal shape and is formed in a box shape having a length along the width direction of the sheet P. The outflow unit 114 has a bottom wall 114B arranged along the transportation direction of the sheet P.

In the device main body 110, in a state in which the open bottom portion of the inflow unit 112 and the open top portion of the outflow unit 114 communicate with each other, the inflow unit 112 and the outflow unit 114 are integrally formed.

The connection pipe 104 connects the blowing machine 102 and a side wall 112S on one end side in a longitudinal direction of the inflow unit 112. Therefore, the wind generated by the blowing machine 102 flows into the inflow unit 112 via the connection pipe 104.

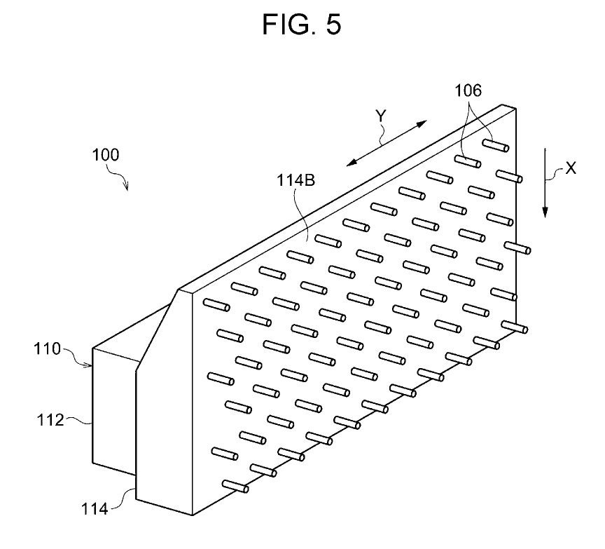

As illustrated in FIG. 5, the plurality of nozzles 106 are arranged two-dimensionally at equal intervals at the bottom wall 114B of the outflow unit 114. That is, the nozzles 106 form nozzle rows by being arranged side by side at equal intervals along the width direction of the sheet P (direction of arrow Y of FIG. 5), and the plurality of nozzle rows are arranged at equal intervals along the transportation direction of the sheet P (direction of arrow X of FIG. 5). As a result, each nozzle 106 is arranged at equal intervals. The nozzles 106 only need to be arranged at equal intervals in at least one of the width direction and the transportation direction of the sheet P.

As illustrated in FIG. 2, each nozzle 106 extends downward from the bottom wall 114B of the outflow unit 114. Each nozzle 106 communicates with an internal portion of the outflow unit 114. Therefore, the wind flows out downward from the outflow unit 114 via each nozzle 106. In the blowing device 100, since blowing is performed via the nozzles 106 arranged at equal intervals, the air volume is uniform in the transportation direction and the width direction of the sheet P.

In the blowing device 100, as illustrated in FIG. 2, the plurality of nozzles 106 face a downstream-side portion of the arc wall 82 and a non-attraction portion 62X (described below) where a sheet P is not attracted in the transportation unit 60. Therefore, specifically, the blowing device 100 presses a sheet P that is being transported by the transportation mechanism 53 against the downstream-side portion of the arc wall 82 and the non-attraction portion 62X by blowing. Here, the transportation unit 60 is arranged on a downstream side of the first guide 80.

In the blowing device 100, since the sheet P is pressed against the arc wall 82 and the non-attraction portion 62X of a transportation belt 62 by blowing, the sheet P can be pressed contactlessly and against the arc wall 82 and the non-attraction portion 62X of the transportation belt 62.

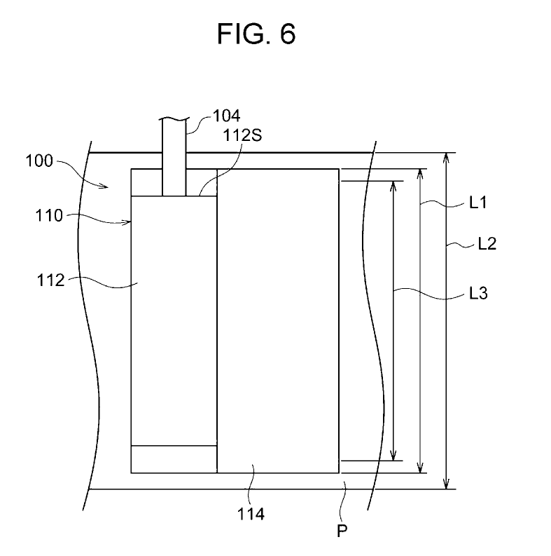

In the blowing device 100, as illustrated in FIG. 6, a width L1 of the device main body 110 is less than a maximum width L2 of a sheet P that is transportable in the image forming apparatus 10. Therefore, a width L3 along the sheet P in a range of arrangement of the nozzles 106 is at least less than the maximum width L2 of the sheet P that is transportable in the image forming apparatus 10. Consequently, in the blowing device 100, blowing can be performed with respect to the sheet P having the maximum width at least in a range that is narrower than the width of the sheet P.

In the blowing device 100, an interval (pitch) of arrangement of the nozzles 106 is, for example, 50 mm or less. The wind speed at an outlet of each nozzle 106 is desirably, for example, 20 m/s or greater.

### Transportation Unit 60

As illustrated in FIG. 2, the transportation unit 60 is arranged on the downstream side of the first guide 80 in the transportation direction of the sheet P so as to face the chains 55. The transportation unit 60 transports the sheet P in a state in which the non-image surface PB of the sheet P is attracted. As illustrated in FIG. 2, the transportation unit 60 has the transportation belt 62, a driven pulley 64, a driving pulley 66, a driving unit 68, and a suction device 70.

The transportation belt 62 is formed in a ring shape (endless form). The transportation belt 62 is composed of a metal belt, such as stainless steel. The thickness of the transportation belt 62 is, for example, 0.5 mm or less.

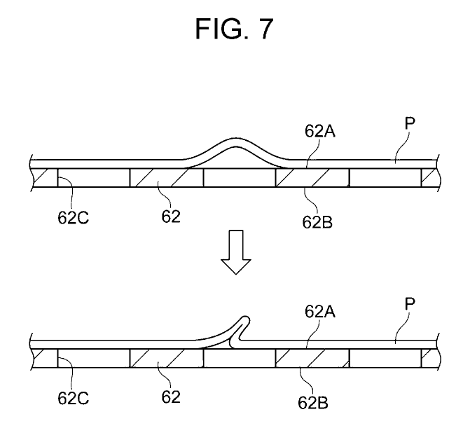

A plurality of attraction holes 62C (refer to FIG. 7) for attracting the sheet P to the transportation belt 62 are formed in the transportation belt 62. By the suction device 70 sucking the sheet P via the attraction holes 62C, the transportation belt 62 causes the non-image surface PB of the sheet P to be attracted to an outer peripheral surface 62A.

The driven pulley 64 and the driving pulley 66 are arranged on a lower side of the chains 55. The driving pulley 66 is arranged on a downstream side in the transportation direction of the sheet P with respect to the driven pulley 64. In addition, the transportation belt 62 is wound with respect to the driven pulley 64 and the driving pulley 66. By the driving unit 68 rotationally driving the driving pulley 66 in a counterclockwise direction in FIG. 2, the transportation belt 62 circulates in the counterclockwise direction in FIG. 2. That is, the transportation belt 62 undergoes circulation movement in the counterclockwise direction in FIG. 2.

In a state in which the transportation belt 62 attracts the non-image surface PB of the sheet P that is being transported by the transportation mechanism 53, the transportation belt 62 itself undergoes circulation movement to transport the sheet P. That is, in the transportation device 50, in a state in which the front end portion of the sheet P is gripped by the transportation mechanism 53 and the non-image surface PB is attracted to the transportation belt 62 in a rear end side with respect to the gripped front end portion, the sheet P is transported by the transportation mechanism 53 and the transportation belt 62. The transportation belt 62 moves while in synchronism with the chains 55.

On the other hand, in an upstream-side portion in the transportation belt 62 with respect to a supporter 90 (described later) of the suction device 70, the sheet P is not attracted to the transportation belt 62. Therefore, the upstream-side portion of the transportation belt 62 with respect to the supporter 90 is an example of the non-attraction portion 62X where the non-image surface PB of the sheet P is not attracted. The non-attraction portion 62X is an example of a contact portion that contacts the non-image surface PB of the sheet P.

As illustrated in FIG. 2, the suction device 70 has a device main body 72, the supporter 90, and the blower 76. The device main body 72 is arranged on an inner peripheral side of the transportation belt 62. The device main body 72 is composed of a box body whose internal portion is hollow. A plurality of suction holes 73 are formed in an upper surface of the device main body 72. The blower 76 is connected to the device main body 72. This causes the blower 76 and the internal portion of the device main body 72 to communicate with each other.

The supporter 90 is formed in a plate shape whose up-down direction is a thickness direction. The supporter 90 is fixed to the upper surface of the device main body 72. Further, the supporter 90 is composed of a porous body. Specifically, the supporter 90 is composed of a foaming body made of a resin material, such as polyethylene (PE). By composing the supporter 90 out of a porous body, ventilation in the up-down direction (thickness direction) is made possible.

An upper surface of the supporter 90 is a supporter surface 92 that supports the transportation belt 62. Specifically, the supporter surface 92 supports the transportation belt 62 in an inner peripheral surface 62B of the transportation belt 62.

By operating the blower 76 (refer to FIG. 2), air is sucked from the internal portion of the device main body 72 to cause the pressure of the internal portion of the device main body 72 to be negative. Therefore, via the suction holes 73 of the device main body 72, holes of the supporter 90, and the attraction holes 62C (refer to FIG. 7) of the transportation belt 62, the sheet P is sucked and the sheet P is attracted to the transportation belt 62. A suction force that pulls towards the supporter 90 also acts upon the transportation belt 62.

In this way, in the transportation unit 60, a portion of the transportation belt 62 arranged at the supporter 90 is an example of an attraction transportation portion 62Y that attracts the non-image surface PB of the sheet P that is being transported in a state in which the sheet P is pressed against the first guide 80 and the non-attraction portion 62X, and that with the transportation mechanism 53 transports the sheet P.

### Drying Unit 42

As illustrated in FIG. 2, the drying unit 42 is arranged on an upper side of the attraction transportation portion 62Y of the transportation belt 62. The drying unit 42 dries a sheet P that is being transported by the attraction transportation portion 62Y. For example, the drying unit 42 has at least one of a blowing unit that sends hot air and an infrared heater. In the drying unit 42, the sheet P is heated by at least one of the hot air and infrared rays and evaporates ink on the sheet P to dry the sheet P.

### Second Guide 52

As illustrated in FIG. 1, the second guide 52 is arranged on a downstream side of the transportation unit 60 in the transportation direction of the sheet P so as to face the chains 55. Therefore, the first guide 80, the transportation unit 60, and the second guide 52 are arranged in this order along a transportation path where the sheet P is transported by the transportation mechanism 53. The second guide 52 is an example of a guide unit that guides the sheet P towards the downstream side in the transportation direction by coming into contact with the non-image surface PB of the sheet P that is being transported by the transportation mechanism 53.

### Sheet Discharge Unit 18

The sheet discharge unit 18 (refer to FIG. 1) is an example of a discharge unit where sheets P dried by the drying unit 42 are discharged after images have been formed by the image forming unit 20. As illustrated in FIG. 1, the sheet discharge unit 18 accommodates sheets P in a state in which the sheets P are stacked.

### Operational Effects of First Embodiment

In the image forming apparatus 10 (refer to FIG. 1), a sheet P supplied from the supply section (not illustrated) is transported by the transportation drum 30 in a state in which the sheet S is attracted to the outer peripheral surface of the transportation drum 30. With respect to the sheet P that is transported by the transportation drum 30, water-based inks of respective colors, cyan (C), magenta (M), yellow (Y), and black (K), are ejected from the ejection heads 22C, 22M, 22Y, and 22K. This causes an image to be formed on the sheet P.

After the sheet P on which the image has been formed has been transferred from the transportation drum 30 to the grippers 57 of the transportation mechanism 53, the sheet P is transported in a state in which the grippers 57 of the transportation mechanism 53 grip a front end portion. After the sheet P that is being transported by the transportation mechanism 53 has been guided to the downstream side in the transportation direction by the first guide 80, the non-image surface PB is attracted to the transportation belt 62. This causes the sheet P to be transported by the transportation mechanism 53 and the transportation belt 62.

The sheet P that is transported by the transportation mechanism 53 and the transportation belt 62 is dried by the drying unit 42. After the sheet P dried by the drying unit 42 has been guided towards the downstream side in the transportation direction by the second guide 52, the sheet P is accommodated at the sheet discharge unit 18.

Here, in a configuration in a case where the image forming apparatus 10 does not include the blowing device 100 (comparative example), in a state in which the transportation mechanism 53 grips the front end portion of the sheet P, in a case where the transportation mechanism 53 transports the sheet P, the sheet P may flutter in a rear end side with respect to the gripped front end portion. In particular, in a case where a rear end portion of the sheet P is transported in an unconstrained state, the rear end side of the sheet P easily flutters. In a case where the sheet P flutters, as illustrated in FIG. 7, a portion that contacts the transportation belt 62 and a portion raised from the transportation belt 62 (a portion where air has flown into a location between the transportation belt 62 and the sheet P) are produced in the sheet P. In this state, in a case where the sheet P is attracted to the transportation belt 62, attraction wrinkles may be produced in the sheet P.

In contrast, in the present embodiment, the blowing device 100 presses the sheet P that is being transported by the transportation mechanism 53 against the downstream-side portion of the arc wall 82 in the first guide 80 and the non-attraction portion 62X of the transportation belt 62 by blowing. This suppresses fluttering of the sheet P. The sheet P that is being transported in a state in which fluttering is suppressed by the blowing by the blowing device 100 is attracted to the attraction transportation portion 62Y of the transportation belt 62 and is transported by the attraction transportation portion 62Y and the transportation mechanism 53. Therefore, it is possible to suppress attraction wrinkles that are produced due to the fluttering of the sheet P.

In the present embodiment, since the sheet P attracted to the transportation belt 62 in a state in which attraction wrinkles are suppressed is dried, it is possible to suppress deterioration in an image caused by the attraction wrinkles.

In the present embodiment, since the blowing device 100 contactlessly presses the sheet P that is being transported by the transportation mechanism 53 against the arc wall 82 and the non-attraction portion 62X by blowing, it is possible to suppress damage to the sheet P. In addition, since the blowing device 100 presses the sheet P contactlessly with respect to the image surface PA of the sheet P, it is possible to suppress deterioration (distortion) in an image caused by contact with the image.

Here, as a configuration that contactlessly presses the sheet P, for example, a configuration that presses by blowing or a mechanism that presses the sheet P by a repelling force using, for example, an electrostatic force or a magnetic force is considered. In the case using an electrostatic force, the sheet P is required to have a predetermined electrical resistance value. In the case using a magnetic force, the sheet P is required to be magnetic. In contrast, in the case using blowing, since the sheet P is not required to have a predetermined electrical resistance value or to be magnetic, the degree of freedom for the types of sheet P applicable as a transport material is high. Even if, as the transport material, a transport material other than the sheet P is used, the degree of freedom for the types that are applicable is high.

In the present embodiment, the blowing device 100 blows from the plurality of nozzles 106 arranged at equal intervals and presses the sheet P. Therefore, compared to a configuration in which the plurality of nozzles 106 are not arranged at equal intervals, it is possible to cause wind to uniformly strike each portion of the sheet P. This makes it is possible to suppress locations of the sheet P that are not sufficiently pressed from being partly produced. That is, it is possible suppress the sheet P from being locally raised from the arc wall 82 and the non-attraction portion 62X.

In the present embodiment, the blowing device 100 is capable of blowing the sheet P having the maximum width in a range that is narrower than the width of the sheet P having the maximum width that is transportable in the image forming apparatus 10. Therefore, it is possible to suppress raising of the sheet P from the first guide 80 and the non-attraction portion 62X of the transportation belt 62 caused by wind flowing from side ends (both ends in the width direction) of the sheet P into locations between the first guide 80 and the non-attraction portion 62X of the transportation belt 62 and the sheet P.

In the present embodiment, the plurality of suction holes 82A and the plurality of attraction holes 62C are formed, respectively, in the arc wall 82 of the first guide 80 and the non-attraction portion 62X of the transportation belt 62. Therefore, the air between the arc wall 82 and the non-attraction portion 62X and the sheet P can be made to escape via the plurality of suction holes 82A and the plurality of attraction holes 62C. This makes it possible to suppress raising of the sheet P from the arc wall 82 and the non-attraction portion 62X caused by the air between the arc wall 82 and the non-attraction portion 62X and the sheet P.

Further, in the present embodiment, the blower 89 sucks air at the outer side of the arc wall 82 via the plurality of suction holes 82A in the first guide 80. This makes it possible to increase the effect of causing the air between the arc wall 82 and the sheet P to escape and to effectively suppress raising of the sheet P from the arc wall 82.

In the present embodiment, the suction force that is generated by the blower 89 in the first guide 80 is smaller than the suction force that is generated by the blower 76 in the transportation unit 60. Therefore, in a case where the transportation belt 62 transports the sheet P, the suction force generated by the blower 89 is unlikely to become transportation resistance.

### Second Embodiment

Next, an image forming apparatus 200 according to a second embodiment is described. Portions having the same functions as those of the aforementioned first embodiment are given the same reference numerals as appropriate and descriptions thereof are omitted as appropriate.

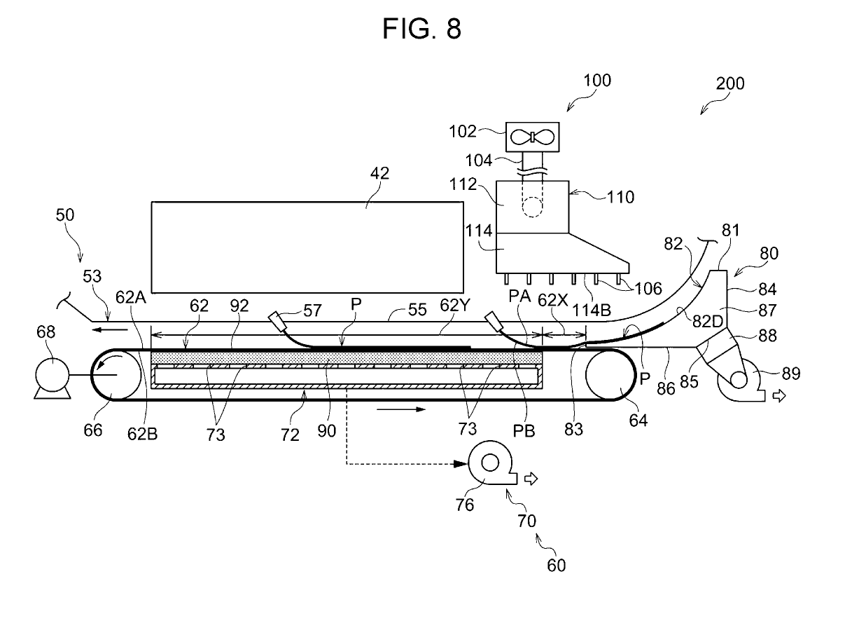

In the aforementioned image forming apparatus 10, the blowing device 100 presses a sheet P that is being transported by the transportation mechanism 53 against the downstream-side portion of the arc wall 82 and the non-attraction portion 62X by blowing. In contrast, in the image forming apparatus 200, as illustrated in FIG. 8, a plurality of nozzles 106 of a blowing device 100 face a downstream-side portion of an arc wall 82 and a non-attraction portion 62X and an upstream-side portion of an attraction transportation portion 62Y in a transportation belt 62. That is, the plurality of nozzles 106 are arranged from the arc wall 82 and the non-attraction portion 62X, where a sheet P is not attracted, to the attraction transportation portion 62Y.

Therefore, in the blowing device 100 of the image forming apparatus 200, the sheet P that is being transported by a transportation mechanism 53 is pressed against the downstream-side portion of the arc wall 82, the non-attraction portion 62X, and the upstream-side portion of the attraction transportation portion 62Y by blowing. The downstream-side portion of the arc wall 82 is a portion including a downstream end of the arc wall 82. The upstream-side portion of the attraction transportation portion 62Y is a portion including an upstream end of the attraction transportation portion 62Y. The other configurations of the image forming apparatus 200 are the same as those of the image forming apparatus 10.

According to the image forming apparatus 200, the blowing device 100 presses the sheet P not only against the arc wall 82 and the non-attraction portion 62X, but also against the attraction transportation portion 62Y. Therefore, since the sheet P is attracted to the attraction transportation portion 62Y while being kept oriented so as to be pressed against the attraction transportation portion 62Y, it is possible to effectively suppress attraction wrinkles that are produced due to fluttering of the sheet P.

### Third Embodiment

Next, an image forming apparatus 300 according to a third embodiment is described. Portions having the same functions as those of the aforementioned first embodiment are given the same reference numerals as appropriate and descriptions thereof are omitted as appropriate.

In the aforementioned image forming apparatus 10, the blowing device 100 performs blowing via the nozzles 106. In contrast, a blowing device 100 of the image forming apparatus 300 does not have a plurality of nozzles 106, and, as illustrated in FIG. 9, is such that slits 115 (examples of openings), which are blowing ports, are formed in a bottom wall 114B (an example of an arrangement member) arranged along the transportation direction of the sheet P (direction of arrow X) in an outflow unit 114. The plurality of slits 115 are formed along an inclination direction in which the slits 115 are inclined with respect to the transportation direction of the sheet P. In the image forming apparatus 300, blowing is performed from the slits 115 to press the sheet P. The other configurations of the image forming apparatus 300 are the same as those of the image forming apparatus 10.

In the image forming apparatus 300, since the slits 115 are inclined with respect to the transportation direction, compared to a configuration in which the slits 115 are formed along the transportation direction of the sheet P, in the width direction of the sheet P, non-uniform air volume is suppressed. In addition, since the slits 115 are inclined with respect to the transportation direction, compared to a configuration in which the slits 115 are formed along the width direction of the sheet P, in the transportation direction of the sheet P, non-uniform air volume is suppressed. Therefore, it is possible to cause wind to uniformly strike each portion of the sheet P. Consequently, it is possible to suppress locations of the sheet P that are not sufficiently pressed from being partly produced.

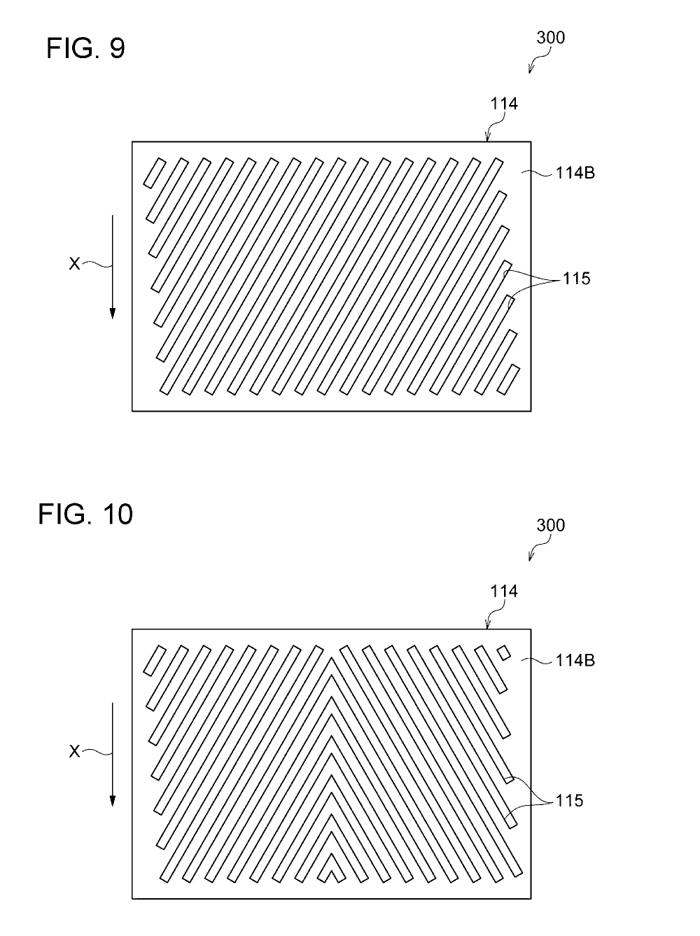

As illustrated in FIG. 10, the slits 115 may each be a configuration in which inclination directions differ with the center in a width direction of the bottom wall 114B being a boundary. That is, the slits 115 only need to be inclined with respect to the transportation direction. The width direction of the bottom wall 114B is the same as the width direction of the sheet P.

### Fourth Embodiment

Next, an image forming apparatus 400 according to a fourth embodiment is described. Portions having the same functions as those of the aforementioned first embodiment are given the same reference numerals as appropriate and descriptions thereof are omitted as appropriate.

In the blowing device 100 of the aforementioned image forming apparatus 10, in the transportation direction and the width direction of the sheet P, the air volume is uniform. In contrast, in the image forming apparatus 400, the blowing device 100 is such that an air volume on the upstream side is smaller than an air volume on the downstream side in the transportation direction. The air volume is the volume of air that is blown out from nozzles 106 per unit time.

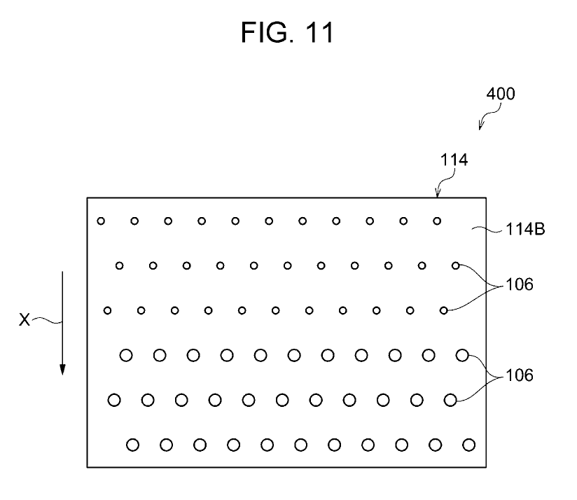

Specifically, in the image forming apparatus 400, as illustrated in FIG. 11, the hole diameters of the nozzles 106 arranged on the upstream side in the transportation direction (direction of arrow X) are smaller than the hole diameters of the nozzles 106 arranged on the downstream side in the transportation direction. More specifically, the hole diameters in the three nozzle rows arranged on the upstream side in the transportation direction are smaller than the hole diameters of the three nozzle rows arranged on the downstream side in the transportation direction. The other configurations of the image forming apparatus 400 are the same as those of the image forming apparatus 10.

Here, in a case where the air volume is large on the upstream side in the transportation direction, a sheet P may be raised from a first guide 80 due to wind flowing into a location between the first guide 80 and the sheet P from side ends (both ends in a width direction) of the sheet P in a state in which its orientation is not stable due to fluttering of a rear end side. In contrast, in the image forming apparatus 400, since the air volume on the upstream side is smaller than the air volume on the downstream side in the transportation direction, the sheet P is unlikely to be raised on the upstream side in the transportation direction. On the other hand, on the downstream side in the transportation direction, since the air volume is larger than on the upstream side, it is possible to increase the pressing force of the sheet P on the downstream side where fluttering is suppressed and the orientation becomes stable. This makes it possible to effectively suppress attraction wrinkles that are produced due to the fluttering of the sheet P.

A configuration in which the hole diameters of the nozzles 106 gradually greatly change towards the downstream side in the transportation direction may be formed. A configuration in which the arrangement density of the nozzles 106 arranged on the downstream side in the transportation direction is larger than the arrangement density of the nozzles 106 arranged on the upstream side in the transportation direction may be formed.

As mentioned above, by controlling the volume of air that is blown out from the nozzles 106 per unit time, while suppressing raising of the sheet P on the upstream side in the transportation direction, it is possible to increase the pressing force of the sheet P on the downstream side in the transportation direction and suppress attraction wrinkles.

### Fifth Embodiment

Next, an image forming apparatus 500 according to a fifth embodiment is described. Portions having the same functions as those of the aforementioned first embodiment are given the same reference numerals as appropriate and descriptions thereof are omitted as appropriate.

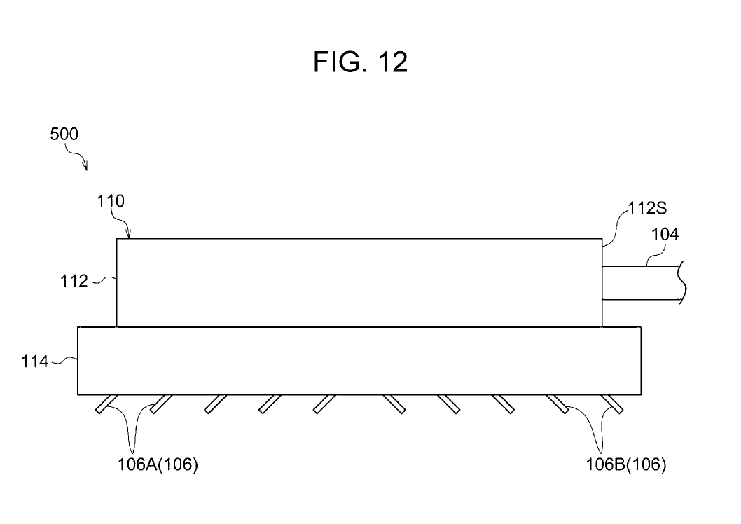

In the blowing device 100 of the aforementioned image forming apparatus 10, the nozzles 106 face downward and the image surface PA of a sheet P is blown from the nozzles 106 in a substantially vertical direction (thickness direction of the sheet P). In contrast, in the image forming apparatus 500, in a plurality of nozzles 106, as illustrated in FIG. 12, nozzles 106A arranged on one end side from a center in the width direction of the sheet P are inclined so that tip portions face the one end side in the width direction of the sheet P as seen in the transportation direction of the sheet P. In the plurality of nozzles 106, nozzles 106B arranged on the other end side from the center in the width direction of the sheet P are inclined so that tip portions face the other end side in the width direction of the sheet P as seen in the transportation direction of the sheet P.

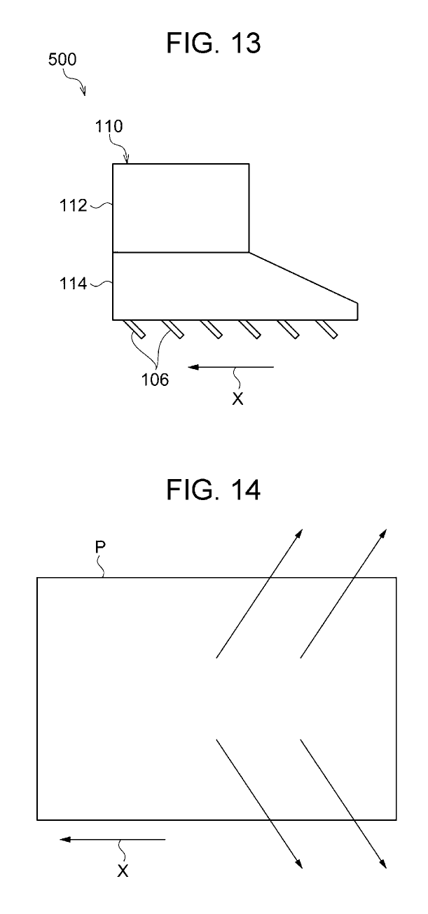

Further, as illustrated in FIG. 13, the plurality of nozzles 106 are inclined so that the front end portions face the upstream side in the transportation direction of the sheet P as seen in the width direction of the sheet P. The other configurations of the image forming apparatus 500 are the same as those of the image forming apparatus 10.

In the image forming apparatus 500, as illustrated in FIG. 14, the sheet P is blown towards both end sides from the center in the width direction of the sheet P and towards the upstream side in the transportation direction. In FIG. 14, the transportation direction of the sheet P is denoted by arrow X.

According to the image forming apparatus 500, it is possible to press and extend the sheet P towards both the end sides from the center in the width direction and towards the upstream side in the transportation direction and to effectively suppress attraction wrinkles.

### Sixth Embodiment

Next, an image forming apparatus 600 according to a sixth embodiment is described. Portions having the same functions as those of the aforementioned first embodiment are given the same reference numerals as appropriate and descriptions thereof are omitted as appropriate.

In the first guide 80 of the aforementioned image forming apparatus 10, in the width direction of the arc wall 82, the opening ratio of the plurality of suction holes 82A is constant. In contrast, in the image forming apparatus 600, the opening ratio of a plurality of suction holes 82A is larger on both end sides in a width direction of an arc wall 82 than at a center side in the width direction.

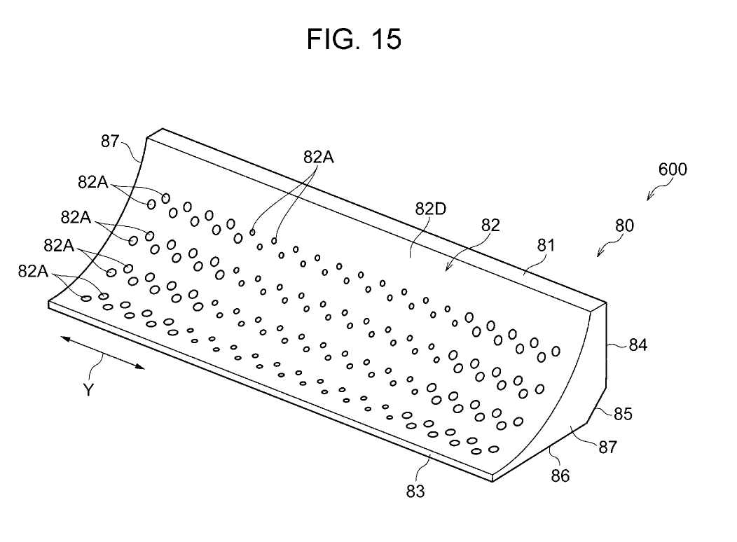

Specifically, in the image forming apparatus 600, as illustrated in FIG. 15, the hole diameters of the suction holes 82A arranged on both the end sides in the width direction of the arc wall 82 (direction of arrow Y) are larger than the hole diameters of the suction holes 82A arranged at the center side in the width direction of the arc wall 82. The other configurations of the image forming apparatus 600 are the same as those of the image forming apparatus 10.

According to the image forming apparatus 600, wind that has flown to side end sides of a sheet P can be made to effectively escape via the plurality of suction holes 82A. Therefore, it is possible to suppress raising of the sheet P from the arc wall 82 caused by wind flowing from the side ends of the sheet P into a location between the arc wall 82 and the sheet P.

By causing the arrangement density on both the end sides in the width direction of the arc wall 82 to be greater than the arrangement density at the center side in the width direction, a configuration in which the opening ratio of the suction holes 82A is greater on both the end sides in the width direction of the arc wall 82 than the center side in the width direction may be formed.

### Seventh Embodiment

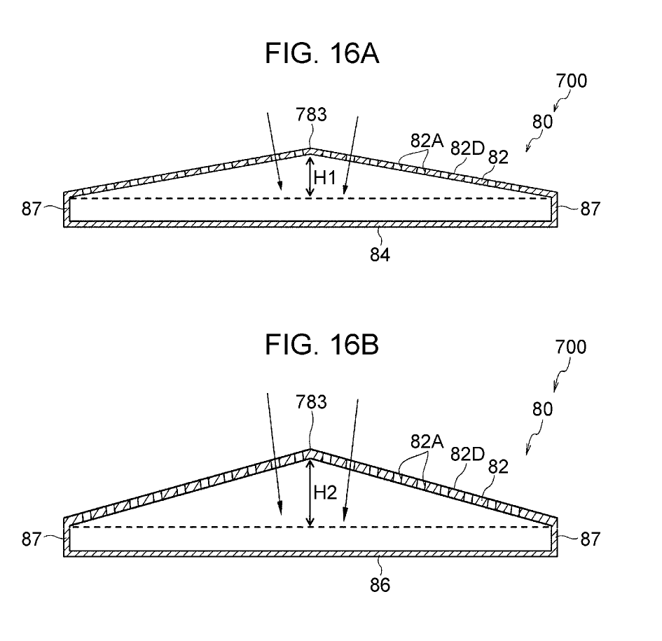

Next, an image forming apparatus 700 according to a seventh embodiment is described. Portions having the same functions as those of the aforementioned first embodiment are given the same reference numerals as appropriate and descriptions thereof are omitted as appropriate. FIG. 16A is a sectional view of an upstream side of a first guide 80 according to a seventh embodiment. FIG. 16B is a sectional view of a downstream side of the first guide 80 according to the seventh embodiment.

In the first guide 80 of the aforementioned image forming apparatus 10, the contact surface 82D of the arc wall 82 is composed of a cylindrical surface along the circulation path of the chains 55. In contrast, as illustrated in FIG. 16, the first guide 80 of the image forming apparatus 700 has a convex portion 783 where the height of a contact surface 82D of an arc wall 82 is higher at the center in the width direction than both end sides in the width direction. Further, the height of the convex portion 783 is higher on the downstream side than on the upstream side in the transportation direction. That is, a height H2 of the convex portion 783 on the downstream side is higher than a height H1 of the convex portion 783 on the upstream side. The other configurations of the image forming apparatus 700 are the same as those of the image forming apparatus 10. In FIGS. 16A and 16B, the heights of the convex portion 783 are exaggerated and illustrated.

According to the image forming apparatus 700, wind from a blowing device 100 flows on the contact surface 82D towards both the end sides from the center in the width direction, and flows towards the upstream side from the downstream side in the transportation direction. Therefore, by wind from the blowing device 100, a sheet P is pressed on the contact surface 82D towards both the end sides from the center in the width direction and towards the upstream side from the downstream side in the transportation direction. Therefore, in the image forming apparatus 700, it is possible to press and extend the sheet P towards both the end sides from the center in the width direction and towards the downstream side in the transportation direction, and to effectively suppress attraction wrinkles.

### Eighth Embodiment

Next, an image forming apparatus 800 according to an eighth embodiment is described. Portions having the same functions as those of the aforementioned first embodiment are given the same reference numerals as appropriate and descriptions thereof are omitted as appropriate.

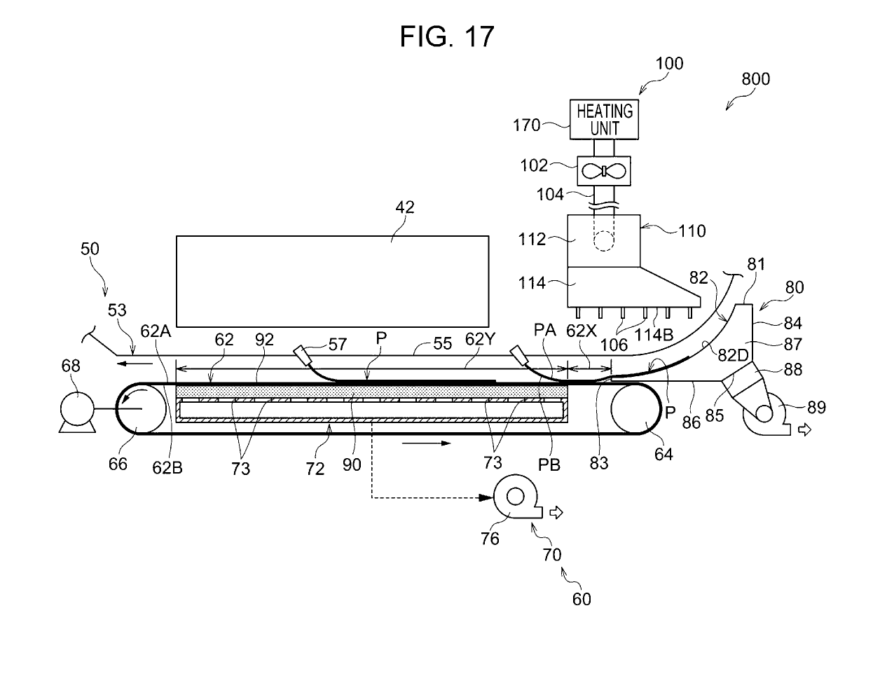

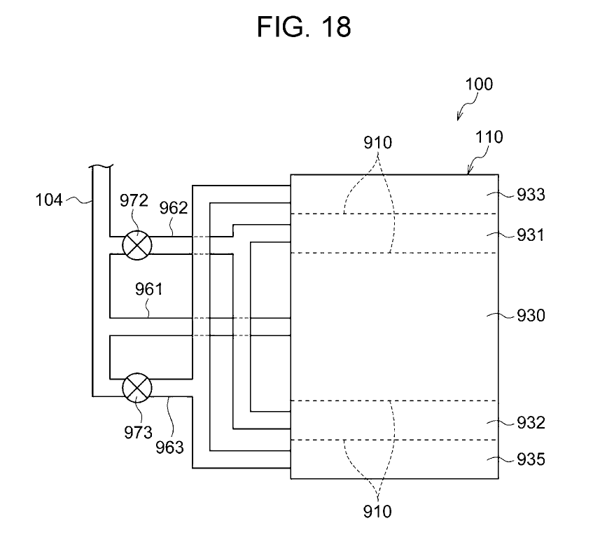

In the blowing device 100 of the aforementioned image forming apparatus 10, by sending wind at normal temperature, a sheet P is pressed. In contrast, in the image forming apparatus 800, as illustrated in FIG. 17, a blowing device 100 has a heating unit 170 that heats air, and the sheet P is pressed by warm air heated by the heating unit 170. The other configurations of the image forming apparatus 800 are the same as those of the image forming apparatus 10. According to the image forming apparatus 800, since, prior to drying by a drying unit 42, warm air can be made to strike the sheet P, the drying of the sheet P is accelerated.

### Modifications of First to Eighth Embodiments

Although, in the first to eighth embodiments, the blowing width along the width direction of the sheet P in the blowing device 100 is not variable, a configuration in which the blowing width is variable may be formed. As a blowing device 100 having a variable blowing width, for example, a configuration that is illustrated in FIG. 18 can be formed.

In the configuration illustrated in FIG. 18, an internal portion of a device main body 110 is partitioned by a partition member 910 into a width-direction central portion 930, a width-direction one end portion 933, a width-direction other end portion 935, a first intermediate portion 931, and a second intermediate portion 932. The first intermediate portion 931 is a portion arranged between the width-direction central portion 930 and the width-direction one end portion 933. The second intermediate portion 932 is a portion arranged between the width-direction central portion 930 and the width-direction other end portion 935. That is, from one end side in the width direction of the sheet P, the internal portion of the device main body 110 is partitioned into the width-direction one end portion 933, the first intermediate portion 931, the width-direction central portion 930, the second intermediate portion 932, and the width-direction other end portion 935 in this order. A connection pipe 104 branches into a first branch pipe 961 that is connected to the width-direction central portion 930, a second branch pipe 962 that is connected to the first intermediate portion 931 and the second intermediate portion 932, and a third branch pipe 963 that is connected to the width-direction one end portion 933 and the width-direction other end portion 935. A valve 972 and a valve 973 are provided at the second branch pipe 962 and the third branch pipe 963, respectively. In this configuration, by closing both of the valves 972 and 973, it is possible to perform blowing at a blowing width of the width-direction central portion 930. In addition, in the present configuration, by opening the valve 972 and closing the valve 973, it is possible to perform blowing at a blowing width of the first intermediate portion 931 and the second intermediate portion 932. Further, in the present configuration, by opening both of the valves 972 and 973, it is possible to perform blowing at a blowing width of the width-direction central portion 930, the first intermediate portion 931, the second intermediate portion 932, the width-direction one end portion 933, and the width-direction other end portion 935.

Although, in the first to eighth embodiments, the image forming apparatuses 10, 200, 300, 400, 500, 600, 700, and 800 (hereunder referred to as the image forming apparatuses 10 to 800) are each an apparatus that forms an image by an ink jet method, they are not limited thereto. The image forming apparatuses may be, for example, an apparatus that forms an image by an electrophotographic method or a printer.

Although, in the first to eighth embodiments, the transportation device 50 is applied to the image forming apparatuses 10 to 800, it is not limited thereto. For example, the transportation device 50 may be applied to other apparatuses that process sheet-shaped transport materials. The transportation device 50 may be singly used.

Although, in the first to eighth embodiments, the transportation unit 60 causes a sheet P to be attracted to the transportation belt 62 by sucking air, it is not limited thereto. The transportation unit 60 may be, for example, a configuration that causes a transport material, such as a sheet P, to be attracted to the transportation belt 62 by electrostatic attraction, and only needs to be one that transports a transport material in a state in which the transport material is attracted.

Although, in the first to eight embodiments, as an example of the sheet-shaped transport material, a sheet P is used, it is not limited thereto. The sheet-shaped transport material may be, for example, a film or a cloth.

Although, in the first to eighth embodiments, a sheet P is contactlessly pressed against the arc wall 82 and the non-attraction portion 62X of the transportation belt 62 by blowing, it is not limited thereto. The configuration that contactlessly presses a sheet P may be a configuration that presses the sheet P by using an electrostatic force or a magnetic force.

Although, in the first to eight embodiments, the transportation device 50 transports a sheet P on which an image has been formed, it is not limited thereto. The transportation device 50 may be one that transports a transport material on which an image is not formed. In this case, as the pressing mechanism, a contact member that contacts the transport material may be used. As the contact member, for example, a contact roller or the like may be used.

The present invention is not limited to the aforementioned embodiments, and various modifications, changes, and improvements are possible within a scope that does not depart from the gist thereof. For example, a plurality of the aforementioned embodiments and modifications may be combined as appropriate to form a configuration.

### Evaluations

In order to confirm the advantageous effects of the configurations of the present application, examples and a comparative example below were evaluated by using the configurations of the image forming apparatus 10 according to the first embodiment (refer to FIG. 1).

### Evaluation Conditions

In the image forming apparatus 10, sheets P dried after forming images were visually observed and evaluated for production of wrinkles. Wrinkles existing in the sheets P dried after forming images are evaluated as being produced when the sheets P are attracted to the transportation belt 62.

In the evaluations, the results of the visual observations were “A” for sheets P having no wrinkles, “B” for sheets P having slightly recognizable wrinkles, and “C” for sheets P having definitely recognizable wrinkles. As the sheets, OK topcoat plus manufactured by Oji Paper Co., Ltd. and having a basis weight of 127 gsm was used.

### Example 1

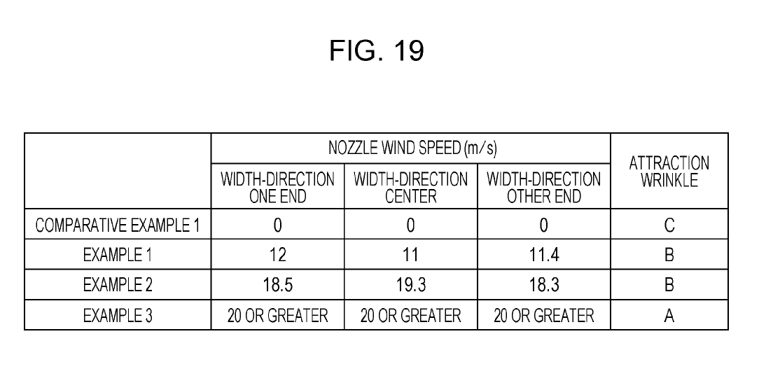

As illustrated in the table of FIG. 19, by operating the image forming apparatus 10 so that the wind speed at the outlet of each nozzle 106 was in a range of 11 m/s or greater to 12 m/s or less, images were formed on the sheets P. In each of the examples, the wind speed is measured at one end, the center, and the other end in the width direction in the device main body 110 of the blowing device 100.

### Example 2

As illustrated in the table of FIG. 19, by operating the image forming apparatus 10 so that the wind speed at the outlet of each nozzle 106 was in a range of 18.3 m/s or greater to 19.3 m/s or less, images were formed on the sheets P.

### Example 3

As illustrated in the table of FIG. 19, by operating the image forming apparatus 10 so that the wind speed at the outlet of each nozzle 106 was in a range of 20 m/s or greater, images were formed on the sheets P.

### Comparative Example 1

In a state in which the blowing from the nozzles 106 was stopped, by operating the image forming apparatus 10, images were formed on the sheets P.

### Evaluation Results

As illustrated in the evaluation results of FIG. 19, in Examples 1 and 2, wrinkles were slightly recognized, and the evaluation was “B”. In Example 3, wrinkles were not recognized, and the evaluation was “A”. In Comparative Example 1, wrinkles were definitely recognized, and the evaluation was “C”.

From the evaluation results above, it is confirmed that production of attraction wrinkles is suppressed by pressing the sheets P.

### REFERENCE SIGNS LIST

10, 200, 300, 400, 500, 600, 700, 800 image forming apparatus
18 sheet discharge unit
20 image forming unit
22C, 22M, 22Y, 22K ejection head
30 transportation drum
32 drum main body
34 gripper
42 drying unit
50 transportation device
52 second guide
53 transportation mechanism
55 chain
57 gripper
60 transportation unit
62 transportation belt
62A outer peripheral surface
62B inner peripheral surface
62C attraction hole
62X non-attraction portion (example of contact portion)
62Y attraction transportation portion
64 driven pulley
66 driving pulley
68 driving unit
70 suction device
72 device main body
73 suction hole
76 blower
80 first guide (example of contact portion)
81 upper wall
82 arc wall
82A suction hole
82D contact surface
83 end wall
84 rear wall
85 inclined wall
86 bottom wall
87 side wall
88 air suction pipe
89 blower (example of suction unit)
90 supporter
92 supporter surface
100 blowing device (example of pressing mechanism)
102 blowing machine
104 connection pipe
106 nozzle
110 device main body
112 inflow unit
112S side wall
114 outflow unit
114B bottom wall (example of arrangement member)
115 slit
170 heating unit
783 convex portion
910 partition member
930 width-direction central portion
931 first intermediate portion
932 second intermediate portion
933 width-direction one end portion
935 width-direction other end portion
961 first branch pipe
962 second branch pipe
963 third branch pipe
972 valve
973 valve
L1 width
L2 maximum width
L3 width
P sheet (example of transport material, example of recording medium)
PA image surface
PB non-image surface

What is claimed is:

1. A transportation device comprising:
a transportation mechanism that, in a state in which a front end portion of a sheet-shaped transport material is gripped, transports the transport material;
a contact portion that is arranged along a transportation path where the transport material is transported by the transportation mechanism, and that contacts one surface of the transport material;
a pressing mechanism that presses the transport material that is being transported by the transportation mechanism against the contact portion; and
an attraction transportation portion that is arranged on a downstream side in a transportation direction of the transport material with respect to the contact portion, that attracts the one surface of the transport material that is being transported in a state in which the transport material is pressed against the contact portion, and that transports with the transportation mechanism the transport material in a state in which the one surface is attracted.

2. The transportation device according to claim 1,
wherein the pressing mechanism presses the transport material that is being transported by the transportation mechanism against the contact portion and the attraction transportation portion.

3. The transportation device according to claim 1,
wherein the pressing mechanism contactlessly presses the transport material that is being transported by the transportation mechanism.

4. The transportation device according to claim 2,
wherein the pressing mechanism contactlessly presses the transport material that is being transported by the transportation mechanism.

5. The transportation device according to claim 3,
wherein the pressing mechanism presses the transport material that is being transported by the transportation mechanism by blowing.

6. The transportation device according to claim 4,
wherein the pressing mechanism presses the transport material that is being transported by the transportation mechanism by blowing.

7. The transportation device according to claim 5,
wherein the pressing mechanism presses the transport material by blowing from a plurality of nozzles arranged at equal intervals.

8. The transportation device according to claim 6,
wherein the pressing mechanism presses the transport material by blowing from a plurality of nozzles arranged at equal intervals.

9. The transportation device according to claim 5,
wherein the pressing mechanism has an arrangement member that is arranged along the transportation direction, a plurality of openings being formed in the arrangement member in an inclination direction in which the openings are inclined with respect to the transportation direction, and
wherein the pressing mechanism presses the transport material by blowing from the openings.

10. The transportation device according to claim 5,
wherein the pressing mechanism blows the transport material in a range that is narrower than a width of the transport material in a direction orthogonal to the transportation direction of the transport material and along the one surface of the transport material.

11. The transportation device according to claim 5,
wherein the pressing mechanism blows the transport material towards both end sides from a center in a width direction orthogonal to the transportation direction of the transport material and along the one surface of the transport material and towards an upstream side in the transportation direction.

12. The transportation device according to claim 1,
wherein the contact portion has a plurality of holes formed in a contact surface that contacts the one surface of the transport material.

13. The transportation device according to claim 5,
wherein the contact portion has a plurality of holes formed in a contact surface that contacts the one surface of the transport material.

14. The transportation device according to claim 12, comprising a suction unit that sucks air via the plurality of holes of the contact portion.

15. The transportation device according to claim 14,
wherein the attraction transportation portion attracts the one surface by a suction force that is generated by sucking air, and
wherein a suction force in the suction unit is smaller than the suction force in the attraction transportation portion.

16. The transportation device according to claim 13,
wherein an opening ratio of the holes is larger on both end sides in a width direction orthogonal to the transportation direction of the transport material and along the one surface of the transport material than at a center side in the width direction.

17. The transportation device according to claim 13,
wherein the contact portion has a convex portion where a contact surface that contacts the one surface of the transport material is higher at a center in a width direction orthogonal to the transportation direction of the transport material and along the one surface of the transport material than both end sides in the width direction, and
wherein a height of the convex portion is higher on the downstream side than on the upstream side in the transportation direction.

18. An image forming apparatus comprising:
an image forming unit that forms an image on an image surface of a recording medium; and
the transportation device according to claim 1 that transports, as the transport material, the recording medium on which the image has been formed by the image forming unit, wherein the contact portion comes into contact with, as the one surface, a non-image surface of the recording medium, and the pressing mechanism contactlessly presses the image surface of the recording medium to press the recording medium against the contact portion.

19. The image forming apparatus according to claim 18,
wherein the image forming unit is an image forming unit that forms the image by water-based ink, and
wherein the image forming apparatus comprises a drying unit that dries the recording medium that is being transported by the transportation mechanism and the attraction transportation portion in a state in which the non-image surface of the recording medium is attracted to the attraction transportation portion of the transportation device.

20. The image forming apparatus according to claim 19,
wherein the pressing mechanism of the transportation device presses the recording medium by warm air.
